(19) United States
(12) Patent Application Publication
(10) Pub. No.: US 2024/0005286 A1
(43) Pub. Date: Jan. 4, 2024

(54) TOUCHLESS MAINTENANCE

(71) Applicant: GM Cruise Holdings LLC, San Francisco, CA (US)

(72) Inventors: Alexander Willem Gerrese, San Francisco, CA (US); Jennifer Devar McKnew, San Francisco, CA (US); Grace Noh, San Francisco, CA (US); Spencer James, San Jose, CA (US); Swarnakshi Kapil, Sunnyvale, CA (US)

(73) Assignee: GM Cruise Holdings LLC, San Francisco, CA (US)

(21) Appl. No.: 17/855,198

(22) Filed: Jun. 30, 2022

(51) Int. Cl. G06Q 10/00; G07C 5/00; G05D 1/00

(52) U.S. Cl. CPC G06Q 10/20; G07C 5/006; G05D 1/0088

(57) ABSTRACT

Systems and methods for an automated process for vehicle service. In particular, an individually owned vehicle is integrated with a service provider platform for a fleet of vehicles such that data flows bidirectionally between the vehicle and the platform. The bidirectional flow of data enables an intelligent and automated end-to-end maintenance and/or repair process for the individually owned vehicle, including issue detection, accident management, and seamless vehicle exchange. For example, the vehicle can send a signal to the platform to schedule a repair and request a replacement vehicle from the platform during the repair. The platform can coordinate with a facility to schedule the repair, send a signal to the vehicle to autonomously drive itself to the scheduled repair, and provide a replacement vehicle to the vehicle's home during the repair.

### TECHNICAL FIELD

The present disclosure relates generally to vehicle maintenance, and more specifically to systems and methods for streamlined vehicle maintenance.

### BACKGROUND

Autonomous vehicles, also known as self-driving cars, driverless vehicles, and robotic vehicles, are vehicles that use multiple sensors to sense the environment and move without human input. Automation technology in the autonomous vehicles enables the vehicles to drive on roadways and to accurately and quickly perceive the vehicle's environment, including obstacles, signs, and traffic lights. The vehicles can be used to pick up passengers and drive the passengers to selected destinations. The vehicles can also be used to pick up packages and/or other goods and deliver the packages and/or goods to selected destinations.

Autonomous vehicles can be part of an autonomous vehicle fleet that provides rides to users and/or picks up and delivers packages. Vehicles generally require regular maintenance checks and occasional recalls that entail visits to an auto shop or other service center. Vehicle owners need to find time to schedule maintenance and other auto shop visits and may also need to find alternative transportation while a vehicle is being serviced. Additionally, vehicle owners may need to wait at an auto shop for a period of time while their vehicle is being serviced.

### SUMMARY

Systems and methods are provided for an automated process for vehicle service. In particular, an individually owned vehicle is integrated with a service provider platform for a fleet of vehicles such that data flows bidirectionally between the vehicle and the platform. The bidirectional flow of data enables an intelligent and automated end-to-end maintenance and/or repair process for the individually owned vehicle, including issue detection, accident management, and seamless vehicle exchange. For example, the vehicle can send a signal to the platform to schedule a repair and request a replacement vehicle from the platform during the repair. The platform can coordinate with a facility to schedule the repair, send a signal to the vehicle to autonomously drive itself to the scheduled repair, and provide a replacement vehicle to the vehicle's home during the repair.

According to one aspect, a method for autonomously providing vehicle maintenance, comprises: receiving, at a central computer, a vehicle service request for a personal vehicle from the personal vehicle; identifying, by the central computer, a service corresponding to the vehicle service request; scheduling the service for the personal vehicle at the central computer; assigning a replacement vehicle for the personal vehicle; and transferring personal vehicle settings to the replacement vehicle.

In some implementations, the method further comprises routing the replacement vehicle to a personal vehicle location at a scheduled service time. In some implementations, assigning the replacement vehicle includes providing the replacement vehicle for a duration of the service. In some implementations, transferring personal vehicle settings includes transferring at least one of a permit, a password, a display setting, a climate setting, and a seat setting. In some implementations, assigning the replacement vehicle includes providing access to a fleet of ridehail vehicles and assigning the replacement vehicle upon receiving a request for the replacement vehicle.

In some implementations, the method further comprises determining whether the vehicle service request is urgent, wherein, when the vehicle service request is urgent, scheduling the service includes identifying an immediately available service vehicle for the service. In some implementations, the method further comprises receiving, at the central computer, a sensor log from the personal vehicle, and providing the sensor log to an incident responder. In some implementations, receiving the sensor log includes receiving personal vehicle video and audio recordings from an incident, wherein the incident triggered the vehicle service request. In some implementations, the method further comprises transmitting a notification of the vehicle service request to a mobile device.

According to some aspects, a system for autonomously providing vehicle maintenance, comprises: a personal vehicle, including: a plurality of sensors to generate personal vehicle sensor data; and a maintenance component to determine when service is needed based on the personal vehicle sensor data and transmit a service request; a fleet of replacement vehicles having adjustable settings; and a vehicle platform to: receive the service request from the personal vehicle; identify a service corresponding to the service request; schedule the service for the personal vehicle; assign a respective replacement vehicle for the personal vehicle from the fleet of replacement vehicles; and transfer personal vehicle settings for the personal vehicle to the replacement vehicle.

In some implementations, the vehicle platform is further to route the respective replacement vehicle to a personal vehicle location at a scheduled service time. In some implementations, the personal vehicle includes a set of personal vehicle settings including at least one of a permit, a password, a display setting, a climate setting, and a seat setting, and wherein the personal vehicle is to transmit the set of personal vehicle settings to the vehicle platform. In some implementations, the fleet of replacement vehicles include a set of ridehail vehicles, and wherein the personal vehicle is further to assign the respective replacement vehicle by providing access to the set of ridehail vehicles. In some implementations, the vehicle platform is further to determine whether the service request is urgent, wherein, when the service request is urgent, the vehicle platform is to identify an immediately available service vehicle for the service. In some implementations, the personal vehicle is further to store personal vehicle sensor data in a sensor log, and wherein the vehicle platform is further to receive the sensor log from the personal vehicle and provide the sensor log to an incident responder. In some implementations, the incident triggered the maintenance component to transmit the service request.

According to another aspect, a method for autonomously receiving vehicle maintenance, comprises: determining, at a maintenance component of a personal vehicle, that service is needed; transmitting a service request from the maintenance component to a central vehicle platform; scheduling a service for the personal vehicle corresponding to the service request; scheduling a replacement vehicle for the personal vehicle during the service; and transmitting personal vehicle settings to the replacement vehicle at a scheduled service time.

In some implementations, storing vehicle sensor data from personal vehicle sensors in a vehicle sensor log, wherein storing vehicle sensor data includes storing personal vehicle video and audio recordings from an incident, and wherein the incident triggered the service request; and transmitting the vehicle sensor log to a central computer. In some implementations, the method further comprises driving to a service center for the service at the scheduled service time. In some implementations, transmitting personal vehicle settings includes transmitting at least one of a permit, a password, a display setting, a climate setting, and a seat setting.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an autonomous vehicle, according to some examples of the present disclosure;

FIG. 2 is a diagram illustrating a method for maintenance of vehicles, according to some examples of the present disclosure;

FIG. 3 is a diagram illustrating another method for maintenance of vehicles, according to some examples of the present disclosure;

FIGS. 4A and 4B illustrate examples of a user interface for touchless vehicle service, according to some examples of the present disclosure;

FIG. 5 illustrates a system for touchless maintenance including personally-owned vehicles and a vehicle platform, according to some examples of the present disclosure;

FIG. 6 is a diagram illustrating a fleet of autonomous vehicles in communication with a central computer, according to some examples of the present disclosure; and

FIG. 7 shows an example embodiment of a system for implementing certain aspects of the present technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Overview

Systems and methods are provided for an automated process for vehicle service. In particular, an individually-managed vehicle (e.g., owned or leased) is integrated with a service provider platform for a fleet of vehicles such that data flows bidirectionally between the vehicle and the platform. The bidirectional flow of data enables an intelligent and automated end-to-end maintenance and/or repair process for the individually owned vehicle, including issue detection, accident management, and seamless vehicle exchange. For example, the vehicle can send a signal to the platform to schedule a repair and request a replacement vehicle from the platform during the repair. The platform can coordinate with a facility to schedule the repair, send a signal to the vehicle to autonomously drive itself to the scheduled repair, and provide a replacement vehicle to the vehicle's home during the repair.

Vehicle ownership includes a responsibility for regular maintenance and occasional repairs (including, e.g., safety recalls) that require bringing the vehicle into an auto shop. However, a trip to the auto shop can be logistically difficult for the vehicle owner, including scheduling time to drop off the vehicle, pick up the vehicle, and/or wait for the vehicle. Additionally, the vehicle owner is without their primary form of transportation during the time the vehicle is in the auto shop, which can be for hours or even days.

Another challenge of vehicle ownership includes the aftermath of a minor accident. In addition to being stressful and dangerous, following an accident, procedures that need to be followed can include exchange of insurance, gathering eyewitness accounts, helping with police reports, etc. In many cases, an accident renders a vehicle immobile, and the vehicle owner can wait hours for a tow truck to arrive during which time the vehicle owner is stranded and in need of alternative transportation.

Thus, systems and methods are provided herein for detecting and/or identifying an issue for which a vehicle needs service, and executing an end-to-end service process, including providing replacement transportation. In some examples, the vehicle in need of service can drive itself to the auto shop. The replacement transportation can include a replacement vehicle and/or access to a ridehail service. In various examples, using systems and methods provided herein, service can be performed on a vehicle with minimal interaction with the vehicle's owner.

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

Example Autonomous Vehicle Configured for Touchless Maintenance

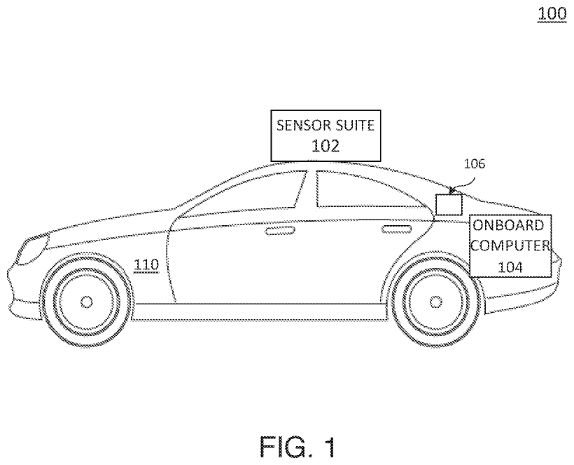

FIG. 1 is a diagram of an autonomous driving system 100 illustrating an autonomous vehicle 110, according to some embodiments of the disclosure. The autonomous vehicle 110 includes a sensor suite 102 and an onboard computer 104. In various implementations, the autonomous vehicle 110 uses sensor information from the sensor suite 102 to determine its location, to navigate traffic, to sense and avoid obstacles, and to sense its surroundings. According to various implementations, the autonomous vehicle 110 is part of a fleet of vehicles for picking up passengers and/or packages and driving to selected destinations. In some examples, the autonomous vehicle 110 includes systems and methods for real time vehicle routing during vulnerable road user encounters. In some examples, the autonomous vehicle 110 includes systems and methods for an automated process for vehicle service. In some examples, the autonomous vehicle 110 includes a touchless maintenance component 106 that communicates vehicle data (e.g., vehicle status or other vehicle information) with a service provider platform, enabling an intelligent and touchless end-to-end maintenance and/or repair process for the vehicle.

The sensor suite 102 includes localization and driving sensors. For example, the sensor suite may include one or more of photodetectors, cameras, radio detection and ranging (RADAR), sound navigation and ranging (SONAR), light detection and ranging (LIDAR), GPS, inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment. As described in greater detail below, information about the autonomous vehicle and the autonomous vehicle's environment as detected by the sensor suite 102 can be logged in a vehicle sensor log. In some examples, sensor suite 102 data can be used by the touchless maintenance component 106 in requesting service and/or repair. In some examples, data from the sensor suite 102 can be used to update a map with information used to develop layers with waypoints identifying various detected items. In some examples, data from the sensor suite 102 can include information regarding crowds and/or lines outside and/or around selected venues. Additionally, sensor suite 102 data can provide localized traffic information. In this way, sensor suite 102 data from many autonomous vehicles can continually provide feedback to the mapping system and the high fidelity map can be updated as more and more information is gathered, with information changing over time.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point-cloud of the region intended to scan. In still further examples, the sensor suite 102 includes RADARs implemented using scanning RADARs with dynamically configurable field of view.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. In some examples, the touchless maintenance component 106 receives and stores processed sensed sensor suite 102 data from the onboard computer 104. In some examples, a vehicle sensor log receives sensor suite 102 data from the sensor suite 102. In some examples, the touchless maintenance component 106 generates a service request based on the vehicle sensor log. In some implementations described herein, the autonomous vehicle 110 includes sensors inside the vehicle. In some examples, the autonomous vehicle 110 includes one or more cameras inside the vehicle. The cameras can be used to detect items or people inside the vehicle. In some examples, the autonomous vehicle 110 includes one or more weight sensors inside the vehicle, which can be used to detect items or people inside the vehicle. In some examples, the interior sensors can be used to detect passengers inside the vehicle. Additionally, based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general-purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, a bicycle, or a scooter. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

Example Methods for Touchless Maintenance

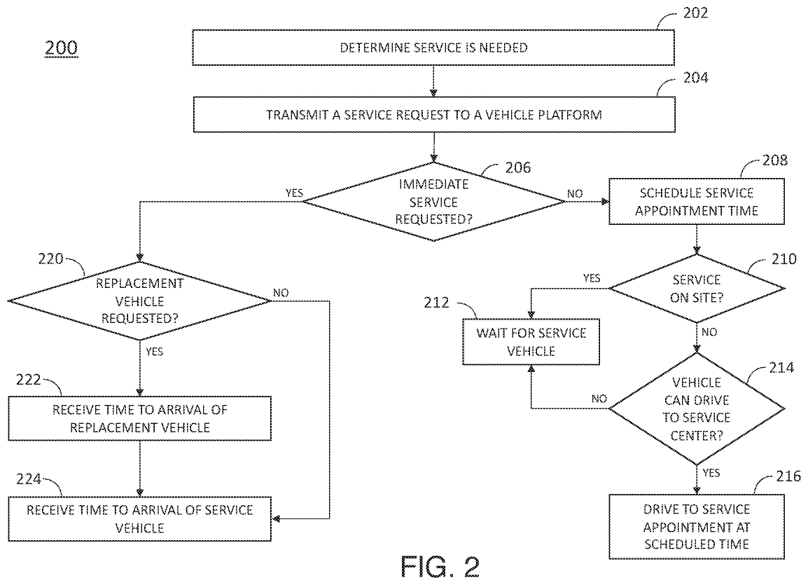

FIG. 2 is a diagram illustrating a method 200 for maintenance of vehicles, according to some examples of the present disclosure. In particular, the method 200 is a method for an individually managed vehicle to request service. In some examples, an individually managed vehicle autonomously requests service. At step 202, the vehicle determines that service is needed. In some examples, the vehicle can determine service is needed for various reasons, such as regular maintenance, a recall notice received at the vehicle from the manufacturer, an issue identified by the vehicle, and/or an accident.

In some examples, regular maintenance is recommended at regular intervals, which can be distance intervals (e.g., every 10,000 miles) and/or time intervals (e.g., annually). When a selected interval has ended, the vehicle automatically determines that maintenance is needed and can begin a service request. In some examples, a vehicle can receive a recall notice directly from the manufacturer. In particular, the onboard computer can be configured to receive recall notices. In some examples, the recall notice can include an urgency rating indicating whether the recall includes a service that should be performed as soon as possible or a service that can wait (e.g., until the vehicle is next being serviced). In some examples, the vehicle can evaluate the recall notice to determine an urgency.

In some examples, the vehicle determines service is needed based on an issue detected by the vehicle (e.g., by vehicle sensors). For example, vehicle sensors may detect an engine issue, a tire issue, an issue with vehicle brakes, and/or an issue with another vehicle component. In some examples, a misaligned or damaged sensor is detected based on non-ideal outputs from the sensor. In some examples, the vehicle determines service is needed following an accident, flat tire, or other issue during operation. In various examples, vehicle systems can identify the issue that disabled the vehicle during operation.

In some examples, when the vehicle determines that service is needed (or receives an indication that service is needed, e.g., from a central computer), the service process is completed autonomously. In some examples, when the vehicle determines that service is needed (or receives an indication that service is needed), the vehicle transmits a notification to its owner's mobile device. For instance, the vehicle owner can have a vehicle application on the mobile device that is in communication with the vehicle. The vehicle can send an alert to the mobile device that service is needed, and, in some examples, via the mobile device application, the vehicle can request permission to request service. Additionally, in some examples, via the mobile device application, the vehicle can provide the owner an option to request a replacement vehicle during the service. In some examples, such as following a collision or other accident, the vehicle may autonomously request service and/or report the collision.

In some examples, when alerted that service is needed, a vehicle owner may decline to send a service request. For example, if the vehicle alerts the owner that service is needed because tire pressure is low, the vehicle owner may choose not to approve a service request and may instead address the problem themselves. Similarly, a vehicle owner may refill windshield washer fluid or replace windshield wiper blades. In some examples, the mobile device application includes information such as locations where free air is available to fill a tire, when the alert indicates low tire pressure. Some vehicle owners may independently replace brake pads. In some examples, certain issues may be categorized as issues an owner may choose to fix independently rather than request service.

At step 204, a service request is transmitted from the vehicle to a vehicle platform. The vehicle platform oversees various aspects of a fleet of vehicles, including fleet management, real time map updates, maintenance, and support. In some examples, the vehicle platform includes a central computer. The vehicle platform also oversees personally-owned vehicles, and personally-owned vehicles can communicate with the vehicle platform via a wireless connection to request service and/or support, and to receive real time maps and/or map updates, among other things. In some examples, the vehicle platform also oversees and/or communicates with vehicles used for other purposes, such as service vehicles, company vehicles, and rideshare vehicles.

At step 206, it is determined whether the service request is for immediate service or for a scheduled service. In some examples, immediate service is requested when a vehicle becomes disabled during use. For instance, if a vehicle becomes stranded on a roadway, immediate service is requested. Similarly, if a vehicle is involved in a collision, especially in a collision that prevents the vehicle from continuing to drive, immediate service is requested. In some examples, a safety-critical recall can result in a vehicle being remotely disabled once it has reached its destination and a replacement vehicle being delivered in its place while the safety-critical issue is repaired.

In other examples, at step 206, it is determined that the service request is not immediate. For instance, if the service request is a regular maintenance request, the service can be scheduled for a future date and time. Similarly, a non-urgent recall may be scheduled for a future date and time. Other services which disable the vehicle may also not result in immediate service requests if the vehicle is parked in a place where it can remain for a period of time (e.g., at “home”). If the vehicle is parked in a place where it can remain, the service may be scheduled for a day and/or time in the near future (e.g., in a few hours, the next day, or in a few days), rather than requesting immediate service.

At step 206, if immediate service is not requested, the method 200 proceeds to step 208, and a service appointment time is scheduled. In some examples, the vehicle and the vehicle platform schedule the service without input from the vehicle owner. In some examples, the vehicle and/or the vehicle platform transmit available service times to the owner's mobile device, and the owner selects a service time. In some examples, the service time is linked to a vehicle calendar, such as to a vehicle chauffer calendar. In various examples, based on the service request, an approximate service duration is determined. If the service duration is above a selected threshold (e.g., longer than an hour), and/or the service appointment does not fit into the vehicle calendar and/or vehicle owner schedule, a replacement vehicle is recommended. For instance, a mobile device application can include a recommendation for a replacement vehicle, and the user can accept or decline the replacement vehicle. In some examples, various parts may need to be ordered for the service, and vehicle service is scheduled for after the parts are due to be delivered to the service center. In some examples, non-urgent service can be scheduled for a time when it is known that nobody will be using the vehicle. For example, service can be scheduled for nighttime while an owner is sleeping, and a vehicle can drive itself to a service center for service and return home again before the morning.

In various examples, scheduling the service appointment at step 208 includes an option of requesting a replacement vehicle for the duration of the service appointment. Similarly, in various examples, scheduling the service appointment at step 208 includes an option of requesting a replacement vehicle for the duration of the time the vehicle is disabled, such that even if service is scheduled a week later, a replacement vehicle can be requested in the interim. In various examples, the personalized settings and account information of the personally owned vehicle that is being serviced are uploaded to the vehicle platform and transferred to the replacement vehicle, such that the replacement vehicle drives and/or behaves like the personally owned vehicle. The personalized settings and account information that can be linked and transferred to the replacement vehicle include seat settings, lighting settings, vehicle display settings, climate control settings, language and accessibility settings, map settings and locations (e.g., home, favorites, previously selected destinations), street parking permits, garage permits, toll payment information (e.g., FastTrack, EZPass), and a chauffeur schedule. Thus, the vehicle owner's current account information is automatically loaded on to the replacement vehicle.

Once the service appointment is scheduled at step 208, at step 210, it is determined whether the service can occur onsite or if the vehicle needs to travel to a service center. In some examples, a service vehicle can travel to the vehicle in need of service to perform the service. For instance, some services that can be performed on site include replacing a cracked windshield, replacing one or more tires, replacing brake pads, and repairing a dent and/or scratch. If the service can be performed on site, at step 212, the vehicle in need of service waits for the service vehicle, which performs the service on site. If the service is to be performed at a service center, at step 214, it is determined whether the vehicle is able to autonomously drive to the service center. If the vehicle can drive to the service center, at step 216, the vehicle drives itself to the service appointment at the scheduled date and time. As discussed above, if parts need to be ordered for the service, the service appointment is scheduled for after the parts are due to be delivered to the service center. If the vehicle is unable to drive autonomously, at step 212, the disabled vehicle waits for a service vehicle, such as a tow truck, which can arrive to pick up the disabled vehicle at the scheduled date and time.

If, at step 206, immediate service is requested, at step 220, it is determined whether a replacement vehicle is requested. If a replacement vehicle request is transmitted to the vehicle platform along with the immediate service request, at step 222, the vehicle receives an estimated time to arrival of the replacement vehicle. In some examples, at step 222, the estimated time to arrival of the replacement vehicle is transmitted to a vehicle owner mobile device and/or a vehicle user mobile device. A replacement vehicle can include a loaner vehicle, such as a vehicle for personal use for the duration of time the disabled vehicle is being serviced. In some examples, the replacement vehicle can be a temporary replacement vehicle, such as a ridehail vehicle to drive the user to their destination. In various examples, the personalized settings of the personally owned disabled vehicle are uploaded to the vehicle platform and then downloaded to the replacement vehicle, such that the replacement vehicle drives and/or behaves like the personally owned vehicle.

In some examples, a replacement vehicle is not requested at step 220, and the method proceeds to step 224. At step 224, the vehicle receives an estimated time to arrival of the service vehicle. In some examples, at step 224, the estimated time to arrival of the service vehicle is transmitted to a vehicle owner mobile device and/or a vehicle user mobile device. In various examples, depending on the type of service, the service vehicle can repair the vehicle on site (e.g., replace a flat tire) or the service vehicle can tow the vehicle to a service center. In some examples, the vehicle may become disabled in an area where the owner and/or passenger can walk to a destination and may prefer not to request a replacement vehicle. In some instances, the vehicle user is automatically offered a ride to a destination, either with a replacement vehicle at step 220, or with another fleet vehicle such as a ridehail vehicle and/or a rideshare vehicle.

In some examples, when a vehicle is involved in an accident, vehicle sensors can be used to enable automated police reports, insurance claims, and/or perform other administrative tasks that accompany such incidents. For example, video and audio provided by recordings from vehicle cameras and microphones can be used to provide an audiovisual account of the incident. Similarly, other vehicle sensors can provide information on the speed of the vehicles involved in the incident at different points in time, including deceleration and acceleration information. Information from the vehicle sensors can also be provided to the vehicle owner after an incident (e.g., via a mobile device, application, and/or website). In some implementations, the vehicle users and/or passengers can leave the scene of the incident and continue to their destination, with the vehicle itself providing any requested information to emergency personnel and other responders. In some examples, a vehicle platform can provide a representative to interact with emergency personnel and other responders on the scene.

In some examples, vehicle sensor data can also be provided to emergency personnel, insurance companies, or others investigating an incident. In some examples, vehicle sensor data can be recorded in a sensor log on a vehicle. In various examples, vehicle sensor data is continuously and/or periodically stored and/or updated in a sensor log on the vehicle. Sensor data can include vehicle location, vehicle direction of travel, number of passengers in the vehicle, surrounding traffic conditions, presence of vulnerable road users, road conditions, weather conditions, visibility, as well as data such as vehicle speed, mileage, tire pressure, battery charge, engine conditions, temperatures (outside, interior cabin, battery, engine, etc.), and sensor data indicating any external contact with the vehicle. In some examples, the vehicle periodically updates this information, such as every second, every five seconds, or any time there is any change to the vehicle (e.g., the vehicle is moved, bumped, etc.).

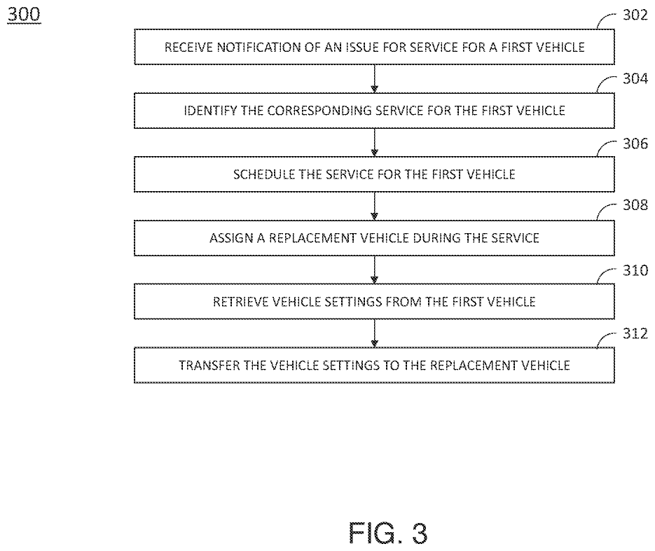

FIG. 3 is a diagram illustrating a method 300 for maintenance of vehicles, according to some examples of the present disclosure. In particular, the method 300 is a method for a vehicle platform to provide service to a vehicle. As described above, the vehicle platform oversees various aspects of a fleet of vehicles, including fleet management, real time map updates, maintenance, and support. The vehicle platform also oversees personally-owned vehicles, and personally-owned vehicles can communicate with the vehicle platform via a wireless connection to request service and/or support, and to receive real time maps and/or map updates, among other things. In some examples, the vehicle platform also oversees and/or communicates with vehicles used for other purposes, such as service vehicles, company vehicles, and rideshare vehicles.

At step 302, the vehicle platform receives a notification of an issue for service for a first vehicle. In some examples, at step 302, the vehicle platform receives data from a first vehicle and determines that service is needed. In some examples, the vehicle platform receives a request for service from the first vehicle. In some examples, the vehicle platform receives a notification of a vehicle recall from a vehicle manufacturer. In some examples, a second vehicle can send a notification to the vehicle platform regarding the first vehicle (e.g., if the second vehicle detects an issue with the first vehicle such as a malfunctioning light or an obstructed license plate). In some examples, the vehicle platform maintains a maintenance schedule of its constituent vehicles and the vehicle platform itself determines that the first vehicle is due for maintenance.

At step 304, the vehicle platform identifies a corresponding service for the first vehicle based on the notification. Additionally, the vehicle platform determines whether the first vehicle needs immediate service or whether service is to be scheduled for a future date and time. The vehicle platform also determines whether the first vehicle can be serviced onsite by a service vehicle, whether the first vehicle needs to be recovered by a service vehicle (e.g., towed), or whether the first vehicle can autonomously drive itself to the service.

At step 306, the vehicle platform schedules the service, which includes scheduling a service vehicle if needed. If the requested service is not immediate, a set of available service appointment times may be transmitted to the vehicle owner via a mobile device application. The vehicle platform may then receive a selected appointment time from the vehicle owner mobile device application. In some examples, the vehicle and the vehicle platform autonomously schedule the service without input from the vehicle owner. In some examples, various parts may need to be ordered for the service, and vehicle service is scheduled for after the parts are due to be delivered to the service center. In various examples, the vehicle platform can determine the parts that are needed, based on metadata of the issue and/or service needed, and the vehicle platform can cause the order to be sent to the service center. In some examples, service is scheduled when the parts are confirmed to have arrived at the service center. In some examples, service is scheduled when the parts are expected to arrive at the service center. In some examples, the vehicle platform can schedule a non-urgent service for the first vehicle for a time when it is known that nobody will be using the first vehicle.

As described above, in some instances, immediate service is requested, and scheduling the service includes identifying a service center for the vehicle and/or assigning a service vehicle to recover the vehicle. In some examples, the vehicle platform identifies service centers equipped to service the first vehicle and selects a service center with immediate availability (or the service center with the soonest availability within a certain radius of the vehicle and/or the vehicle's home). Similarly, in some examples, the vehicle platform identifies a service vehicle corresponding to the recovery service needed that is available and most quickly able to recover the first vehicle.

In some examples, when the first vehicle is involved in an accident, the vehicle platform can coordinate with emergency personnel and other responders to enable automated police reports, insurance claims, and/or perform other administrative tasks that accompany such incidents. For example, video and audio provided by recordings from vehicle cameras and microphones can be used to provide an audiovisual account of the incident, and these recordings can be transferred from the first vehicle to the vehicle platform. Similarly, other vehicle sensors can provide information on the speed of the vehicles involved in the incident at different points in time, including deceleration and acceleration information. Information from the vehicle sensors can also be provided to the vehicle owner after an incident (e.g., via a mobile device, application, and/or website). In some examples, a vehicle platform can provide a representative to interact with emergency personnel and other responders on the scene. Thus, in some implementations, the vehicle users and/or passengers can leave the scene of the incident and continue to their destination, with the vehicle platform, the representative, and the first vehicle itself providing any requested information to emergency personnel and other responders.

In various examples, once the first vehicle is evaluated by a service vehicle and/or service technician, a quote for repair can be transmitted to the first vehicle owner mobile device application. The first vehicle owner can choose whether to accept the quote and direct the service center to proceed with the service. Additionally, the first vehicle owner's mobile device application can be used to keep the first vehicle owner informed of the status of the first vehicle and its repairs. In some examples, the vehicle owner can monitor their vehicle during service to track its location, view updated information about steps of the service completed (e.g., oil changed but tire pressure not yet filled), and/or view live footage from vehicle cameras and/or microphones. In some examples, the vehicle records footage during the repair that a vehicle owner can view later. In some examples, other cameras record the repair for the vehicle owner. Similarly, vehicle sensors can be used to allow a vehicle owner to view the vehicle as it is being towed by a tow truck (e.g., sensors on the owned vehicle, and/or sensors on the tow truck).

At step 308, a replacement vehicle is assigned to the first vehicle owner for use during the service. In some examples, the replacement vehicle is the same make and model as the first vehicle. In some examples, the replacement vehicle is a similar make and model as the first vehicle. In some examples, the replacement vehicle is an upgraded version of the first vehicle. At step 310, the vehicle platform retrieves first vehicle settings and account information from the first vehicle, including user preferences such as seat settings, lighting settings, vehicle display settings, climate control settings, language and accessibility settings, map settings and locations (e.g., home, favorites, previously selected destinations), a chauffeur schedule, street parking permits, garage permits, and toll payment information (e.g., FastTrack, EZPass), as well as various user accounts (e.g., vehicle permits, vehicle transponder account information, login information for applications used in the vehicle, etc.). At step 312, the vehicle platform transfers the first vehicle settings and personal account information from the first vehicle to the replacement vehicle. In some examples, the transfer links any data associated with the personalized first vehicle to the temporary vehicle, including map settings and locations (e.g., home, favorites, previously selected destinations), street parking permits, garage permits, toll payment information (e.g., FastTrack, EZPass), and in-vehicle applications (e.g., streaming service applications, messaging applications, mobile device connection, etc.). Thus, the vehicle owner's current account information is loaded on to the replacement vehicle, making the replacement vehicle feel and operate very similarly to the first vehicle to the vehicle owner.

In various examples, the replacement vehicle can be selected from an inventory of vehicles at a depot that are specifically designated as replacement vehicles to be used for this purpose. In some examples, the replacement vehicle is selected from a fleet of ridehail and/or rideshare vehicles. In some instances, an available vehicle from a ridehail and/or rideshare fleet may be nearby and more quickly available than a vehicle from a depot. In some examples, a vehicle platform can provide a ridehail and/or rideshare ride in place of an immediate replacement vehicle. In some examples, a vehicle platform can provide a ridehail and/or rideshare ride to the user's current destination and provide a replacement vehicle at a later time (e.g., a few hours later), as the replacement vehicle becomes available.

In general, the methods 200 and 300 can be performed automatically, and the bidirectional flow of information between the vehicle platform and the vehicle triggers a set of actions that enables automated vehicle service (including maintenance logistics) with little to no input from vehicle owners. The methods 200 and 300 allow vehicle owners continuous access to a vehicle, even when service is needed, with no need to schedule personal time or service appointments.

Example Interface for Touchless Maintenance

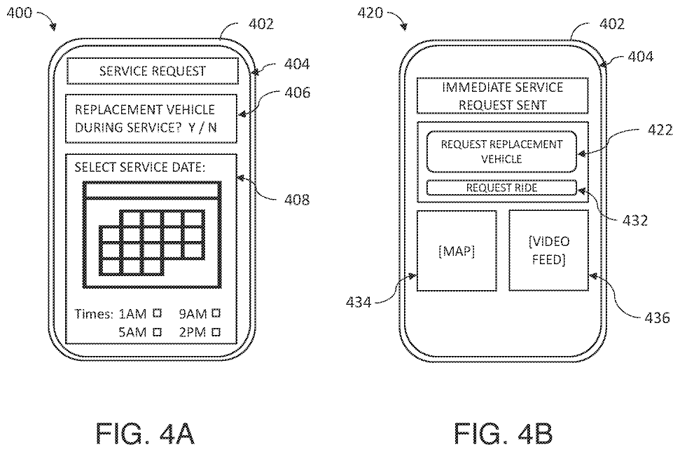

FIGS. 4A and 4B illustrate examples 400, 420 of a user interface for touchless vehicle service, according to various examples of the present disclosure. In various examples, as described above, a vehicle owner is informed on the service needed by the personally owned vehicle. In some examples, the vehicle owner is informed of the service request sent by the personally owned vehicle to the vehicle platform. FIG. 4A is an example 400 of a device 402 showing a service request interface 404 in a vehicle application. In particular, the vehicle owner has an application on a mobile device that interfaces with the personally owned vehicle. In various examples, the vehicle application can be used to unlock and/or lock the vehicle, open various vehicle doors, set vehicle interior temperature, turn on or off vehicle heated seats, check vehicle cameras, check vehicle charge, review and/or change various vehicle settings, schedule vehicle software updates, and review vehicle messages. The vehicle application can also be used to provide alerts and/or notifications of vehicle error messages and any services needed for the personally owned vehicle.

In some implementations, the vehicle application includes the service request interface 404. The service request interface provides the mobile device user (e.g., the vehicle owner) the option in box 406 to request a replacement vehicle during the service. When a replacement vehicle is requested, the service request interface may present the user with an option to transfer personal vehicle settings to the replacement vehicle. Additionally, the service request interface includes a scheduling box 408, in which the mobile device user can select the date and time for the service. In some examples, the mobile device user can click on a date in the calendar, and available service times on that date are displayed underneath the calendar. In various examples, as described with respect to FIGS. 2 and 3, the vehicle can autonomously drive itself to the service center at the scheduled date and time. In some examples, a replacement vehicle arrives at the owned vehicles location (e.g., parking space, driveway, garage) before the vehicle drives to the service appointment, and the replacement vehicle parks in the space where the owned vehicle had been parked.

In some examples, a service request is autonomously transmitted from the owned vehicle to the vehicle platform and the service request interface informs the vehicle owner of the service request and provides the vehicle owner the option to cancel a replacement vehicle request. In some examples, the vehicle application includes settings in which the mobile device user/vehicle owner can select whether service requests are automatically transmitted by the owned vehicle by default or whether the service request is first reviewed and approved via the vehicle application. Similarly, vehicle settings in the vehicle application can provide the mobile device user the option to select whether a replacement vehicle is automatically requested when the owned vehicle is being serviced.

FIG. 4B is another example 420 of the device 402 showing a service request interface 404 in a vehicle application. In particular, the example 420 shows a notification of an immediate service request. In some examples, if the owned vehicle becomes disabled or stranded while driving, the owned vehicle automatically and autonomously transmits an immediate service alert to the vehicle platform. The immediate service alert can include an identification of the type of service needed, as described above with respect to FIGS. 2 and 3. The owned vehicle also alerts the mobile device application user (e.g., the vehicle owner) of the immediate service request. As shown in the example 420, the mobile device user is provided an option to request a replacement vehicle (box 422) and/request a ride (box 432). In some examples, the ride can be a ridehail and/or rideshare ride, and the ride may be available more quickly than a replacement vehicle. In some examples, the replacement vehicle may take longer to arrive than a ridehail ride, but the vehicle owner can keep the replacement vehicle for the duration of the service. When a replacement vehicle is requested, the service request interface may present the user with an option to transfer personal vehicle settings to the replacement vehicle. In some examples, the vehicle owner can request an immediate ride to a destination and subsequently request a replacement vehicle to be delivered to a selected location at a later time. In some examples, the replacement vehicle is a vehicle from a ridehail and/or rideshare ride fleet.

The service request interface 404 shown in FIG. 4B also includes a map 434 and a video feed 436. In some examples, the map 434 shows the owned vehicle's current location. Once a replacement vehicle request and/or ride request is submitted, the map 434 can also show the location of the replacement vehicle and/or ride. In some examples, the video feed 436 can show a video feed from the owned vehicle. In some examples, the video feed 436 can show a video feed of the owned vehicle.

Example System for Touchless Maintenance

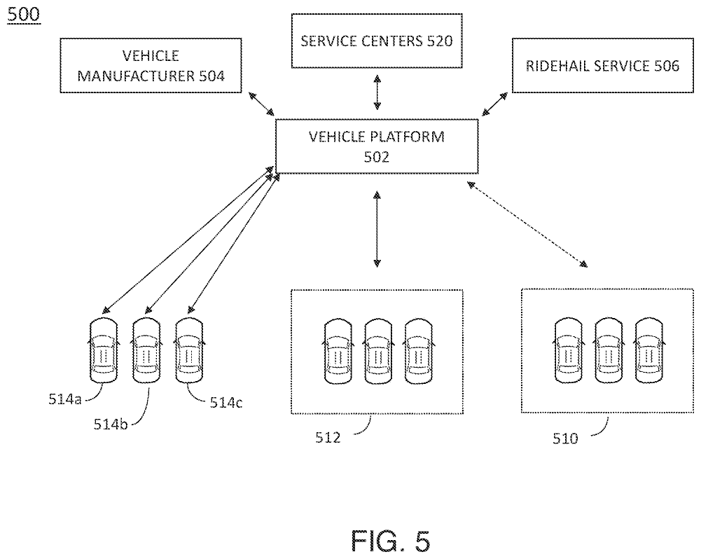

FIG. 5 illustrates a system for touchless maintenance including personally-owned vehicles 514a, 514b, 514c, and a vehicle platform 502, according to various examples of the present disclosure. In particular, FIG. 5 illustrates a vehicle platform 502 in communication with three different sets of vehicles. In some examples, the first set of vehicles 510 include ridehail and/or rideshare vehicles. The first set of vehicles 510 can include a fleet of autonomous vehicles that drive in a selected area, providing rides within the area. The first set of vehicles 510 can be in communication with a ridehail service 506 to provide rides ordered through the ridehail service. In some examples, the second set of vehicles 512 includes autonomous vehicles from a vehicle depot of replacement vehicles. Thus, the vehicles in the second set of vehicles 512 are used to replace individually owned vehicles when the individually owned vehicles are being serviced. The third set of vehicles includes personally-owned vehicles 514a, 514b, 514c, which are each owned by an individual or entity. The vehicle platform 502 oversees various aspects of the vehicles 510, 512, and 514a-514c, including fleet management, real time map updates, maintenance, and support.

In some examples, the vehicle platform 502 is in communication with one or more manufacturers 504 of the personally-owned vehicles 514a, 514b, 514c. In some examples, the vehicle platform 502 can receive vehicle recall notices and/or vehicle update notices from the vehicle manufacturer(s) 504. The vehicle platform 502 can alert the personally-owned vehicles 514a, 514b, 514c of any services needed based on communications from the vehicle manufacturer(s) 504 and the vehicle platform 502 can then proceed to schedule the corresponding service(s). In some examples, one or more of the personally-owned vehicles 514a, 514b, 514c are in communication with the respective manufacturer of the vehicle 514a, 514b, 514c, and receives vehicle recall notices and/or vehicle update notices directly from the vehicle manufacturer 504. The respective personally-owned vehicle 514a, 514b, 514c can then communicate with the vehicle platform 502 to schedule the corresponding service.

In general, the personally-owned vehicles 514a, 514b, 514c are in communication with the vehicle platform 502, for example via a wireless connection. In some examples, the personally-owned vehicles 514a, 514b, 514c can request service and/or support via the vehicle platform 502. The vehicle platform 502 coordinates with multiple service centers 520 to provide maintenance and repair support to the personally-owned vehicles 514a, 514b, 514c as requested. The service centers 520 can include autobody shops, repair shops, maintenance centers, service vehicles, tow trucks, and any other vehicle service providers. The service center 520 selected for any particular service can depend on the specific service requested.

When a service request is received from personally-owned vehicle 514a, 514b, 514c, the vehicle platform 502 can automatically arrange a replacement vehicle for the duration of the service. In some examples, the vehicle platform 502 selects a replacement vehicle from the second set of vehicles 512, which are available specifically for this purpose. In some examples, the vehicle platform 502 coordinates with a ridehail service 506 to provide a replacement vehicle from the first set of vehicles 510, which are typically designated as ridehail and/or rideshare vehicles. In some examples, the vehicle platform 502 coordinates with a ridehail service 506 to provide one or more rides in a ridehail and/or rideshare vehicle from the first set of vehicles 510. In some examples, the vehicle platform 502 selects a replacement vehicle from the second set of vehicles 512, and, if the replacement vehicle will take a period of time to arrive, the vehicle platform 502 also provides one or more rides in a ridehail and/or rideshare vehicle from the first set of vehicles 510.

In some examples, the vehicle platform 502 can communicate with vehicle applications on user mobile devices corresponding to the personally-owned vehicles 514a, 514b, 514c. For example, the vehicle platform 502 can send a service alert to a user mobile device via the vehicle application. Similarly, via the vehicle application on a user mobile device, the vehicle platform 502 can request approval for service, schedule a day and time for service, inquire whether the user would like a replacement vehicle during service, and provide updates to while a personally-owned vehicle 514a, 514b, 514c is being serviced. In some examples, the personally-owned vehicles 514a, 514b, 514c each communicate with a respective user mobile device to provide service-related alerts, updates, and notifications.

Example of Autonomous Vehicle Fleet

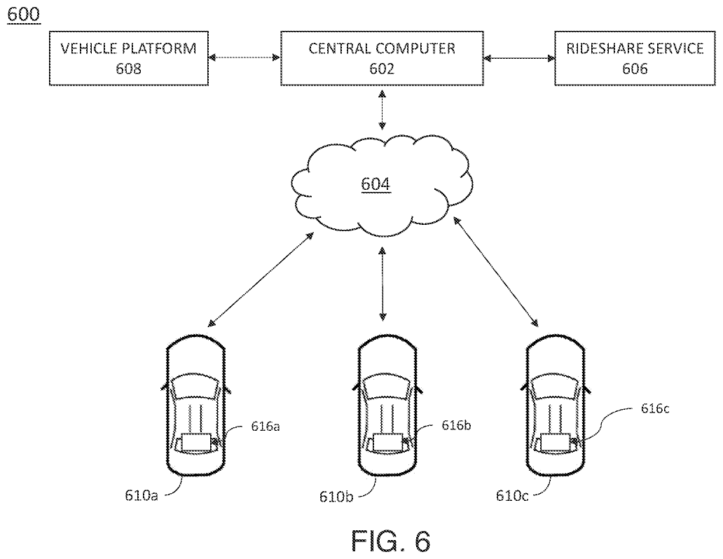

FIG. 6 is a diagram 600 illustrating a fleet of autonomous vehicles 610a, 610b, 610c in communication with a central computer 602, according to some embodiments of the disclosure. The vehicles 610a-610c communicate wirelessly with a cloud 604 and a central computer 602. The central computer 602 includes a routing coordinator and a database of information from the vehicles 610a-610c in the fleet. Autonomous vehicle fleet routing refers to the routing of multiple vehicles in a fleet. The central computer also acts as a centralized ride management system and communicates with ridehail users via a ridehail service 606. Via the ridehail service 606, the central computer receives ride requests from various user ridehail applications. Additionally, in some examples, the central computer communicates with a vehicle platform 608, where the vehicle platform 608 coordinates updates and services for personally-owned vehicles. In some implementations, the autonomous vehicles 610a-610c communicate directly with each other. The autonomous vehicles 610a-610c each include a vehicle touchless maintenance component 616a, 616b, 616c as described above with respect to the vehicle touchless maintenance component 106 of FIG. 1.

When a ride request is entered at a ridehail service 606, the ridehail service 606 sends the request to the central computer 602. If the ridehail request is for a future date, the central computer 602 stores the information for future routing determinations. In some examples, on the day of the ride request, during a selected period of time before the ride begins, the vehicle to fulfill the request is selected and route for the vehicle is generated by the routing coordinator. In other examples, the vehicle to fulfill the request is selected and the route for the vehicle is generated by the onboard computer on the autonomous vehicle. In various examples, information pertaining to the ride Is transmitted to the selected vehicle 610a-610c. With shared rides, the route for the vehicle can depend on other passenger pick-up and drop-off locations. Each of the autonomous vehicles 610a, 610b, 610c in the fleet record sensor data in a vehicle sensor log. In some examples, each of the autonomous vehicles 610a, 610b, 610c in the fleet includes a touchless maintenance component 616a, 616b, 616c, which can generate a service request in the event the respective vehicle 610a, 610b, 610c needs service. The vehicles 610a, 610b, 610c communicate with the central computer 602 via the cloud 604.

As described above, each vehicle 610a-610c in the fleet of vehicles communicates with a routing coordinator. Thus, information gathered by various autonomous vehicles 610a-610c in the fleet can be saved and used to generate information for future routing determinations. For example, sensor data can be used to generate route determination parameters. In general, the information collected from the vehicles in the fleet can be used for route generation or to modify existing routes. In particular, routes can be modified based on a vehicle event log received from another vehicle. In some examples, the routing coordinator collects and processes position data from multiple autonomous vehicles in real-time to avoid traffic and generate a fastest-time route for each autonomous vehicle. In some implementations, the routing coordinator uses collected position data to generate a best route for an autonomous vehicle in view of one or more traveling preferences and/or routing goals. In some examples, the routing coordinator uses collected position data corresponding to emergency events to generate a best route for an autonomous vehicle to avoid a potential emergency situation and associated unknowns. Similarly, in some examples, the routing coordinator uses collected position data corresponding to high-risk situations to generate a best route for an autonomous vehicle to avoid a high-risk situation and associated unknowns. In some examples, data gathered by the routing coordinator can be communicated with personally-owned vehicles to generate a best route.

According to various implementations, a set of parameters can be established that determine which metrics are considered (and to what extent) in determining routes or route modifications. For example, expected congestion or traffic based on a known event can be considered. Generally, a routing goal refers to, but is not limited to, one or more desired attributes of a routing plan indicated by at least one of an administrator of a routing server and a user of the autonomous vehicle. The desired attributes may relate to a desired duration of a route plan, a comfort level of the route plan, a vehicle type for a route plan, safety of the route plan, and the like. For example, a routing goal may include time of an individual trip for an individual autonomous vehicle to be minimized, subject to other constraints. As another example, a routing goal may be that comfort of an individual trip for an autonomous vehicle be enhanced or maximized, subject to other constraints.

Routing goals may be specific or general in terms of both the vehicles they are applied to and over what timeframe they are applied. As an example of routing goal specificity in vehicles, a routing goal may apply only to a specific vehicle, or to all vehicles in a specific region, or to all vehicles of a specific type, etc. Routing goal timeframe may affect both when the goal is applied (e.g., some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

Some examples of routing goals include goals involving trip duration (either per trip, or average trip duration across some set of vehicles and/or times), physics, and/or company policies (e.g., adjusting routes chosen by users that end in lakes or the middle of intersections, refusing to take routes on highways, etc.), distance, velocity (e.g., max., min., average), source/destination (e.g., it may be optimal for vehicles to start/end up in a certain place such as in a pre-approved parking space or charging station), intended arrival time (e.g., when a user wants to arrive at a destination), duty cycle (e.g., how often a car is on an active trip vs. idle), energy consumption (e.g., gasoline or electrical energy), maintenance cost (e.g., estimated wear and tear), money earned (e.g., for vehicles used for ridehailing), person-distance (e.g., the number of people moved multiplied by the distance moved), occupancy percentage, higher confidence of arrival time, user-defined routes or waypoints, fuel status (e.g., how charged a battery is, how much gas is in the tank), passenger satisfaction (e.g., meeting goals set by or set for a passenger) or comfort goals, environmental impact, toll cost, etc. In examples where vehicle demand is important, routing goals may include attempting to address or meet vehicle demand.

Routing goals may be combined in any manner to form composite routing goals; for example, a composite routing goal may attempt to optimize a performance metric that takes as input trip duration, ridehail revenue, and energy usage and also, optimize a comfort metric. The components or inputs of a composite routing goal may be weighted differently and based on one or more routing coordinator directives and/or passenger preferences.

Likewise, routing goals may be prioritized or weighted in any manner. For example, a set of routing goals may be prioritized in one environment, while another set may be prioritized in a second environment. As a second example, a set of routing goals may be prioritized until the set reaches threshold values, after which point a second set of routing goals takes priority. Routing goals and routing goal priorities may be set by any suitable source (e.g., an autonomous vehicle routing platform, an autonomous vehicle passenger).

The routing coordinator uses maps to select an autonomous vehicle from the fleet to fulfill a ride request. In some implementations, the routing coordinator sends the selected autonomous vehicle the ride request details, including pick-up location and destination location, and an onboard computer on the selected autonomous vehicle generates a route and navigates to the destination. In some implementations, the routing coordinator in the central computer 602 generates a route for each selected autonomous vehicle 610a-610c, and the routing coordinator determines a route for the autonomous vehicle 610a-610c to travel from the autonomous vehicle's current location to a first destination.

Example of a Computing System for Touchless Maintenance

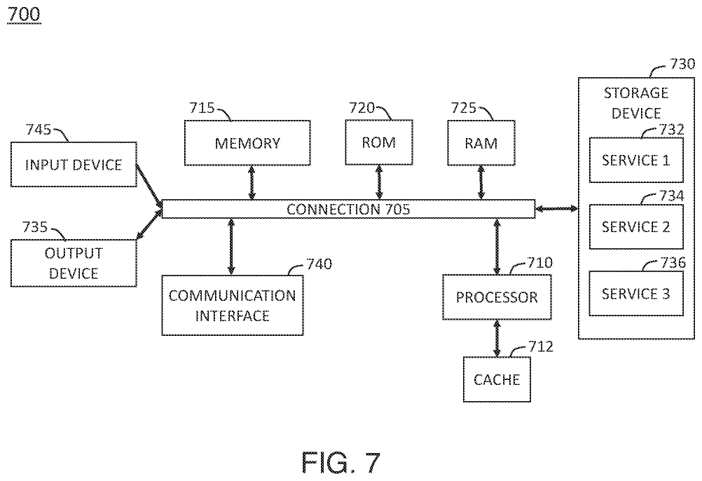

FIG. 7 shows an example embodiment of a computing system 700 for implementing certain aspects of the present technology. In various examples, the computing system 700 can be any computing device making up the onboard computer 104, the central computer 602, or any other computing system described herein. The computing system 700 can include any component of a computing system described herein which the components of the system are in communication with each other using connection 705. The connection 705 can be a physical connection via a bus, or a direct connection into processor 710, such as in a chipset architecture. The connection 705 can also be a virtual connection, networked connection, or logical connection.

In some implementations, the computing system 700 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

The example system 700 includes at least one processing unit (CPU or processor) 710 and a connection 705 that couples various system components including system memory 715, such as read-only memory (ROM) 720 and random access memory (RAM) 725 to processor 710. The computing system 700 can include a cache of high-speed memory 712 connected directly with, in close proximity to, or integrated as part of the processor 710.

The processor 710 can include any general-purpose processor and a hardware service or software service, such as services 732, 734, and 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

In some examples, one or more of the services 732, 734, 736 includes a touchless maintenance component to analyze input, for example input from vehicle sensors, and identify service and maintenance needs. The touchless maintenance component can receive vehicle recall notifications. Additionally, the touchless maintenance component can evaluate data from a vehicle sensor log that stores vehicle sensor data. The sensor data from the vehicle sensor log can be transmitted via the connection 705 to other components of the computing system 700. In other examples, sensor data is stored in another location such as in memory 715 and/or in a storage device 730. Sensor data can change frequently as a vehicle drives and its environment changes, and thus the vehicle sensor log can also be frequently updated. The touchless maintenance component can access current vehicle sensor data via the connection 705, and can generate a vehicle service request when appropriate. The vehicle service request can be communicated, e.g., with a vehicle platform and/or a central computer, via the communication interface 740.

To enable user interaction, the computing system 700 includes an input device 745, which can represent any number of input mechanisms, such as a microphone for speech, a touch-sensitive screen for gesture or graphical input, keyboard, mouse, motion input, speech, etc. The computing system 700 can also include an output device 735, which can be one or more of a number of output mechanisms known to those of skill in the art. In some instances, multimodal systems can enable a user to provide multiple types of input/output to communicate with the computing system 700. The computing system 700 can include a communications interface 740, which can generally govern and manage the user input and system output. There is no restriction on operating on any particular hardware arrangement, and therefore the basic features here may easily be substituted for improved hardware or firmware arrangements as they are developed.

A storage device 730 can be a non-volatile memory device and can be a hard disk or other types of computer-readable media which can store data that are accessible by a computer, such as magnetic cassettes, flash memory cards, solid state memory devices, digital versatile disks, cartridges, RAMs, ROMs, and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as a processor 710, a connection 705, an output device 735, etc., to carry out the function.

As discussed above, each vehicle in a fleet of vehicles communicates with a routing coordinator. When a vehicle is flagged for service, the routing coordinator schedules the vehicle for service and routes the vehicle to the service center. When the vehicle is flagged for maintenance, a level of importance or immediacy of the service can be included. As such, service with a low level of immediacy will be scheduled at a convenient time for the vehicle and for the fleet of vehicles to minimize vehicle downtime and to minimize the number of vehicles removed from service at any given time. In some examples, the service is performed as part of a regularly-scheduled service. Service with a high level of immediacy may require removing vehicles from service despite an active need for the vehicles.

Routing goals may be specific or general in terms of both the vehicles they are applied to and over what timeframe they are applied. As an example of routing goal specificity in vehicles, a routing goal may apply only to a specific vehicle, or to all vehicles of a specific type, etc. Routing goal timeframe may affect both when the goal is applied (e.g., urgency of the goal, or, some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

In various implementations, the routing coordinator is a remote server or a distributed computing system connected to the autonomous vehicles via an Internet connection. In some implementations, the routing coordinator is any suitable computing system. In some examples, the routing coordinator is a collection of autonomous vehicle computers working as a distributed system.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### SELECT EXAMPLES

Example 1 provides a method for autonomously providing vehicle maintenance, comprising: receiving, at a central computer, a vehicle service request for a personal vehicle from the personal vehicle; identifying, by the central computer, a service corresponding to the vehicle service request; scheduling the service for the personal vehicle at the central computer; assigning a replacement vehicle for the personal vehicle; and transferring personal vehicle settings to the replacement vehicle.

Example 2 provides a method, system, and/or vehicle according to one or more of the preceding and/or following examples, further comprising routing the replacement vehicle to a personal vehicle location at a scheduled service time.

Example 3 provides a method, system, and/or vehicle according to one or more of the preceding and/or following examples, wherein assigning the replacement vehicle includes providing the replacement vehicle for a duration of the service.

Example 4 provides a method, system, and/or vehicle according to one or more of the preceding and/or following examples, wherein transferring personal vehicle settings includes transferring at least one of a permit, a password, a display setting, a climate setting, and a seat setting.

Example 5 provides a method, system, and/or vehicle according to one or more of the preceding and/or following examples, wherein assigning the replacement vehicle includes providing access to a fleet of ridehail vehicles and assigning the replacement vehicle upon receiving a request for the replacement vehicle.

Example 6 provides a method, system, and/or vehicle according to one or more of the preceding and/or following examples, further comprising determining whether the vehicle service request is urgent, wherein, when the vehicle service request is urgent, scheduling the service includes identifying an immediately available service vehicle for the service.

Example 7 provides a method, system, and/or vehicle according to one or more of the preceding and/or following examples, further comprising receiving, at the central computer, a sensor log from the personal vehicle, and providing the sensor log to an incident responder.

Example 8 provides a method, system, and/or vehicle according to one or more of the preceding and/or following examples, wherein receiving the sensor log includes receiving personal vehicle video and audio recordings from an incident, wherein the incident triggered the vehicle service request.

Example 9 provides a method, system, and/or vehicle according to one or more of the preceding and/or following examples, further comprising transmitting a notification of the vehicle service request to a mobile device.

Example 10 provides a system for autonomously providing vehicle maintenance, comprising: a personal vehicle, including: a plurality of sensors to generate personal vehicle sensor data; and a maintenance component to determine when service is needed based on the personal vehicle sensor data and transmit a service request; a fleet of replacement vehicles having adjustable settings; and a vehicle platform to: receive the service request from the personal vehicle; identify a service corresponding to the service request; schedule the service for the personal vehicle; assign a respective replacement vehicle for the personal vehicle from the fleet of replacement vehicles; and transfer personal vehicle settings for the personal vehicle to the replacement vehicle.

Example 11 provides a method, system, and/or vehicle according to one or more of the preceding and/or following examples, wherein the vehicle platform is further to route the respective replacement vehicle to a personal vehicle location at a scheduled service time.

Example 12 provides a method, system, and/or vehicle according to one or more of the preceding and/or following examples, wherein the personal vehicle includes a set of personal vehicle settings including at least one of a permit, a password, a display setting, a climate setting, and a seat setting, and wherein the personal vehicle is to transmit the set of personal vehicle settings to the vehicle platform

Example 13 provides a method, system, and/or vehicle according to one or more of the preceding and/or following examples, wherein the fleet of replacement vehicles include a set of ridehail vehicles, and wherein the personal vehicle is further to assign the respective replacement vehicle by providing access to the set of ridehail vehicles.

Example 14 provides a method, system, and/or vehicle according to one or more of the preceding and/or following examples, wherein the vehicle platform is further to determine whether the service request is urgent, wherein, when the service request is urgent, the vehicle platform is to identify an immediately available service vehicle for the service.

Example 15 provides a method, system, and/or vehicle according to one or more of the preceding and/or following examples, wherein the personal vehicle is further to store personal vehicle sensor data in a sensor log, and wherein the vehicle platform is further to receive the sensor log from the personal vehicle and provide the sensor log to an incident responder.

Example 16 provides a method, system, and/or vehicle according to one or more of the preceding and/or following examples, wherein the incident triggered the maintenance component to transmit the service request.

Example 17 provides a method for autonomously receiving vehicle maintenance, comprising: determining, at a maintenance component of a personal vehicle, that service is needed; transmitting a service request from the maintenance component to a central vehicle platform; scheduling a service for the personal vehicle corresponding to the service request; scheduling a replacement vehicle for the personal vehicle during the service; and transmitting personal vehicle settings to the replacement vehicle at a scheduled service time.

Example 18 provides a method, system, and/or vehicle according to one or more of the preceding and/or following examples, storing vehicle sensor data from personal vehicle sensors in a vehicle sensor log, wherein storing vehicle sensor data includes storing personal vehicle video and audio recordings from an incident, and wherein the incident triggered the service request; and transmitting the vehicle sensor log to a central computer.

Example 19 provides a method, system, and/or vehicle according to one or more of the preceding and/or following examples, further comprising driving to a service center for the service at the scheduled service time.

Example 20 provides a method, system, and/or vehicle according to one or more of the preceding and/or following examples, wherein transmitting personal vehicle settings includes transmitting at least one of a permit, a password, a display setting, a climate setting, and a seat setting.

Example 21 provides a method for autonomously providing vehicle maintenance, comprising: receiving, at a central computer, vehicle data for a personal vehicle from the personal vehicle; identifying, by the central computer, a vehicle service request corresponding to the vehicle data and a service corresponding to the vehicle service request; scheduling the service for the personal vehicle at the central computer; assigning a replacement vehicle for the personal vehicle; and transferring personal vehicle settings to the replacement vehicle.

Example 22 provides a method, system, and/or vehicle according to one or more of the preceding and/or following examples, wherein the vehicle data includes a vehicle service request.

Example 23 provides a method, system, and/or vehicle according to one or more of the preceding and/or following examples, further comprising generating, at the central computer, the vehicle service request based on the vehicle data.

Example 24 provide a method for autonomously receiving vehicle maintenance, comprising: transmitting vehicle data from a maintenance component of a personal vehicle to a central vehicle platform; receiving, at a mobile device application linked to the personal vehicle, a notification to schedule a service for the personal vehicle based on the vehicle data; scheduling, via the mobile device application, the service for the personal vehicle; scheduling, via the mobile device application, a replacement vehicle for the personal vehicle during the service; and transmitting personal vehicle settings to the replacement vehicle at a scheduled service time.

### VARIATIONS AND IMPLEMENTATIONS

According to various examples, driving behavior includes any information relating to how an autonomous vehicle drives. For example, driving behavior includes how and when the autonomous vehicle actuates its brakes and its accelerator, and how it steers. In particular, the autonomous vehicle is given a set of instructions (e.g., a route or plan), and the driving behavior determines how the set of instructions is implemented to drive the car to and from various destinations, and, potentially, to stop for passengers or items. Driving behavior may include a description of a controlled operation and movement of an autonomous vehicle and the manner in which the autonomous vehicle applies traffic rules during one or more driving sessions. Driving behavior may additionally or alternatively include any information about how an autonomous vehicle calculates routes (e.g., prioritizing fastest time vs. shortest distance), other autonomous vehicle actuation behavior (e.g., actuation of lights, windshield wipers, traction control settings, etc.) and/or how an autonomous vehicle responds to environmental stimulus (e.g., how an autonomous vehicle behaves if it is raining, or if an animal jumps in front of the vehicle). Some examples of elements that may contribute to driving behavior include acceleration constraints, deceleration constraints, speed constraints, steering constraints, suspension settings, routing preferences (e.g., scenic routes, faster routes, no highways), lighting preferences, action profiles (e.g., how a vehicle turns, changes lanes, or performs a driving maneuver), and action frequency constraints (e.g., how often a vehicle changes lanes). Additionally, driving behavior includes information relating to whether the autonomous vehicle drives and/or parks.

As will be appreciated by one skilled in the art, aspects of the present disclosure, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, or one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting.

Other features and advantages of the disclosure will be apparent from the description and the claims. Note that all optional features of the apparatus described above may also be implemented with respect to the method or process described herein and specifics in the examples may be used anywhere in one or more embodiments.

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

1. A method for autonomously providing vehicle maintenance, comprising:
receiving, at a central computer, vehicle data for a personal vehicle from the personal vehicle via a wireless signal, wherein the central computer is configured to manage a plurality of autonomous vehicles;
identifying, by the central computer, a vehicle service request corresponding to the vehicle data and a service corresponding to the vehicle service request;
receiving, in conjunction with the vehicle service request, a replacement vehicle request;
transmitting available service times to a mobile device application associated with the personal vehicle and receiving a service time selection;
scheduling the service for the personal vehicle at the central computer;
assigning a replacement vehicle for the personal vehicle;
transmitting, from the central computer to the mobile device application, map information including a current location of the replacement vehicle, for display on the mobile device application;
uploading, via the wireless signal, personal vehicle settings from the personal vehicle to the central computer; and
transferring personal vehicle settings from the central computer to the replacement vehicle, wherein personal vehicle settings include a vehicle calendar.

2. The method of claim 1, further comprising routing the replacement vehicle to a personal vehicle location at a scheduled service time, wherein the replacement vehicle autonomously drives to the personal vehicle location at the scheduled service time.

3. The method of claim 2, wherein assigning the replacement vehicle includes providing the replacement vehicle for a duration of the service.

4. The method of claim 1, wherein uploading and transferring personal vehicle settings includes uploading and transferring at a permit, a password, a display setting, a climate setting, a seat setting, toll payment account information, and application login information for applications running on the personal vehicle.

5. The method of claim 1, wherein assigning the replacement vehicle includes providing access to a fleet of ridehail vehicles and assigning the replacement vehicle upon receiving a request for the replacement vehicle.

6. The method of claim 1, further comprising determining whether the vehicle service request is urgent, wherein, when the vehicle service request is urgent, scheduling the service includes identifying an immediately available service vehicle for the service.

7. The method of claim 1, further comprising receiving, at the central computer, a sensor log from the personal vehicle, and providing the sensor log to an incident responder.

8. The method of claim 7, wherein receiving the sensor log includes receiving personal vehicle video and audio recordings from an incident, wherein the incident triggered the vehicle service request.

9. The method of claim 1, further comprising transmitting a notification of the vehicle service request to a mobile device.

10. A system for autonomously providing vehicle maintenance, comprising:
a personal vehicle, including:
a plurality of sensors to generate personal vehicle sensor data; and
a maintenance component to determine when service is needed based on the personal vehicle sensor data and transmit a service request;
a fleet of replacement vehicles having adjustable settings; and
a vehicle platform to manage the fleet of replacement vehicles, and to:
receive the service request from the personal vehicle via a wireless signal, wherein the service request includes a replacement vehicle request;
identify a service corresponding to the service request;
transmit available service times to a mobile device application associated with the personal vehicle and receiving a service time selection;
schedule the service for the personal vehicle;
assign a respective replacement vehicle for the personal vehicle from the fleet of replacement vehicles;
transmit, to the mobile device application, map information including a current location of the respective replacement vehicle, for display on the mobile device application;
uploading personal vehicle settings from the personal vehicle; and
transfer personal vehicle settings for the personal vehicle from the vehicle platform to the respective replacement vehicle, wherein personal vehicle settings include a vehicle schedule.

11. The system of claim 10, wherein the vehicle platform is further to route the respective replacement vehicle to a personal vehicle location at a scheduled service time, wherein the respective replacement vehicle is to autonomously drive to the personal vehicle location, and wherein the personal vehicle is to autonomously drive to a service location for the scheduled service.

12. The system of claim 10, wherein the personal vehicle includes a set of personal vehicle settings including a permit, a password, a display setting, a climate setting, a seat setting, toll payment account information, and application login information, and wherein the personal vehicle is to transmit, via a wireless signal, the set of personal vehicle settings to the vehicle platform.

13. The system of claim 10, wherein the fleet of replacement vehicles include a set of ridehail vehicles, and wherein the personal vehicle is further to assign the respective replacement vehicle by providing access to the set of ridehail vehicles.

14. The system of claim 10, wherein the vehicle platform is further to determine whether the service request is urgent, wherein, when the service request is urgent, the vehicle platform is to identify an immediately available service vehicle for the service.

15. The system of claim 14, wherein the personal vehicle is further to store personal vehicle sensor data in a sensor log, and wherein the vehicle platform is further to receive the sensor log from the personal vehicle and provide the sensor log to an incident responder.

16. The system of claim 15, wherein the sensor log includes personal vehicle video and audio recordings from an incident, wherein the incident triggered the maintenance component to transmit the service request.

17. A method for autonomously receiving vehicle maintenance, comprising:
transmitting vehicle data from a maintenance component of a personal vehicle to a central vehicle platform;
receiving, at a mobile device application linked to the personal vehicle, a notification to schedule a service for the personal vehicle based on the vehicle data;
scheduling, via the mobile device application, the service for the personal vehicle;
scheduling, via the mobile device application, a replacement vehicle for the personal vehicle during the service;
receiving, at the mobile device application, map information including a current location of the replacement vehicle, for display on the mobile device application;
uploading personal vehicle settings from the personal vehicle to the central vehicle platform before the service;
autonomously driving the personal vehicle to a service location for the service at a scheduled service time; and
transmitting personal vehicle settings from the central vehicle platform to the replacement vehicle the scheduled service time, wherein personal vehicle settings include a vehicle chauffeur schedule.

18. (canceled)

19. The method of claim 17, further comprising:
storing vehicle sensor data from personal vehicle sensors in a vehicle sensor log, wherein storing vehicle sensor data includes storing personal vehicle video and audio recordings from an incident, and wherein the incident triggered a service request; and
transmitting the vehicle sensor log to a central computer.

20. The method of claim 17, wherein transmitting personal vehicle settings includes transmitting a permit, a password, a display setting, a climate setting, a seat setting, toll payment information, and application login information for applications running on the personal vehicle.

21. The method of claim 1, further comprising receiving, at the central computer, a notification from a third vehicle of an issue with the personal vehicle.
